(19) United States
(12) Patent Application Publication
(10) Pub. No.: US 2011/0268839 A1
(43) Pub. Date: Nov. 3, 2011

(54) Bread dough and bread product with reduced oil absorption, and production process thereof

(75) Inventors: Yoshinobu Hiraoka, Matsuyama-shi (JP); Eri Ousaka, Matsuyama-shi (JP); Toshio Hiraki, Matsuyama-shi (JP); Hiroshi Harada, Ozu-shi (JP); Junji Tsujita, Matsuyama-shi (JP)

(73) Assignees: EHIME PREFECTURE; CHUON CO., LTD.; SEIJITSUMURA CO., LTD.

(21) Appl. No.: 12/662,735

(22) Filed: Apr. 30, 2010

(51) Int. Cl. A21D 8/02; A21D 13/08; A21D 13/00

(52) U.S. Cl. 426/18; 426/549; 426/560; 426/556

(57) ABSTRACT

The present invention provides bread crumbs that have an advantage of reduced oil absorption during deep-frying; and a production process thereof. The present invention further provides deep-fried food products and food products for deep-frying food product prepared using the bread crumbs, and a method of reducing oil absorption of bread crumbs. The present invention produces bread crumbs by carrying out the steps of:
preparing bread dough by incorporating at least one member selected from the group consisting of konnyaku gel and konnyaku sol into ingredients of the bread dough;
fermenting the bread dough, and baking the bread dough; and
pulverizing the baked bread.

### TECHNICAL FIELD

The present invention relates to bread products such as bread crumbs, doughnuts or deep-fried breads and bread dough for the bread products, which are reduced oil absorption during deep-frying, and their production methods. The present invention further relates to deep-fried food products and food products for deep-frying that are prepared using particularly the bread crumbs. The present invention still further relates to a method of reducing oil absorption of the bread products.

### BACKGROUND ART

Deep-fried products coated with bread crumbs have been consumed in large quantities due to their crispy textures, which are derived from deep-frying and the particular taste of bread crumbs. In particular, along with recent improvements in frozen food manufacturing and distribution techniques, the production volume of deep-fried products has further increased. Deep-fried foods are consumed not only in meals at home, but are also used in the food service industry and takeout food industry.

Further, bread products produced by deep-frying yeast-leavened bread dough, such as doughnuts or deep-fried breads, have also been consumed in large quantities due to the crispy surface textures and particular taste they derive from deep-frying.

When cooking such deep-fried food products, the moisture contained in the bread crumbs, bread dough, or material is exchanged with the oil used for frying. This serves to transfer heat to the food, and also improves the crispy texture and taste. On the other hand, since the bread dough or the bread crumbs coating the surfaces of deep-fried food products hold a large amount of oil, these deep-fried foods are high in calories. For this reason, it has been said that the overeating of deep-fried food products is likely to result in excessive calorie intake and increase the risk of conditions, such as obesity or adult diseases, of so-called metabolic syndrome. Accordingly, along with the recent health consciousness of consumers and their caution against adult diseases or obesity, such deep-fried food products have begun to be considered an immediate cause of excessive calorie intake, and the market demand therefor has decreased.

Under such circumstances, there has been a demand for bread crumbs or bread dough with reduced oil absorption during deep-frying, which can be conducive to calorie reduction in deep-fried foods.

The following prior art documents disclose processes for bread crumb production. Japanese Unexamined Patent Publication No. 1994-169717 discloses a process of producing bread crumbs, comprising mixing raw materials of bread dough with protease or amylase to cause enzymolysis of gluten protein and starch in the bread. Japanese Unexamined Patent Publication No. 1995-246072 discloses a process comprising incorporating dietary fibers made of corn and protein made of soybean into bread crumbs. Japanese Unexamined Patent Publication No. 2003-284519 and Japanese Unexamined Patent Publication No. 2008-11864 disclose a process of producing bread crumbs from bread containing the shell or other components of krill, the method succeeding in decreasing the size of air bubbles in the bread while increasing the amount of foaming. Japanese Unexamined Patent Publication No. 1996-56597 discloses a process of producing bread crumbs using a transglutaminase that acts on the flour. Japanese Unexamined Patent Publication No. 2004-208634 discloses a process of producing bread crumbs that involves mixing an alginic acid, or a combination of alginic acid and a polysaccharide thickener with flour, and acting a transglutaminase on the flour. Japanese Unexamined Patent Publication No. 2005-80584 discloses a process of producing bread crumbs using an oil absorption blocker that contains a high-glutathione dry yeast as an active ingredient. Japanese Unexamined Patent Publication No. 2006-271329 discloses a process of producing bread crumbs by incorporating a water-soluble dietary fiber into the raw materials of bread dough.

The above-mentioned Japanese Unexamined Patent Publication No. 2006-271329 discloses glucomannan (konnyaku mannan) as a water-soluble dietary fiber. Glucomannan is a water-soluble dietary fiber prepared from konnyaku, which is a traditional Japanese food. However, the above document teaches mixing unprocessed glucomannan with the raw materials of bread.

### DISCLOSURE OF THE INVENTION

### Technical Problem

An object of the present invention is to provide a low-calorie bread product (bread crumbs, doughnuts, deep-fried breads, etc.) with reduced oil absorption, that has a pleasant texture, can easily drain off the oil, and can be used as a material of deep-fried products with reduced oil absorption by deep-frying.

The present invention also provides a production method for the bread product. Another object of the present invention is to provide a method for reducing oil absorption of the bread products. Still another object of the present invention is to provide deep-fried food products and food products for deep-frying prepared by using the aforementioned bread crumbs.

### Technical Solution

The inventors of the present invention conducted intensive studies to achieve the foregoing objects, and created bread crumbs from a bread that is prepared by mixing konnyaku powder processed into a sol or a gel with raw materials of bread dough, and baking the dough after fermentation. The inventors found that the bread crumbs have significantly lower oil absorption than those produced by a usual method, and that the oil can be easily drained off from the bread crumbs. The inventors further confirmed that the bread crumbs are useful in the production of deep-fried food products, which is one of the unachieved conventional objectives; that the deep-fried products had a pleasant crispy texture; and that the stickiness incidental to deep-fried products was reduced. The inventors further confirmed that the bread crumb coating of the deep-fried food products prepared by using the bread crumbs produced by the method of the present invention did not become overly moist even when reheated in a microwave oven, thereby keeping the fried texture.

Furthermore, the inventors produced doughnuts and deep-fried breads by mixing konnyaku powder processed into a sol or a gel with raw materials of bread dough, and frying the dough after fermentation. The inventors confirmed that the resulting doughnuts and deep-fried breads had significantly lower oil absorption than those produced by a usual method, and that the oil can be easily drained off from the product. The doughnuts and deep-fried breads were confirmed to qualify as commodities that could be marketed as low-calorie doughnuts and deep-fried breads.

The present invention was completed based on these findings, and includes the following embodiments.

(I) Bread Product with Reduced Oil Absorption, Bread Dough of the Bread Product, and their Production Methods.
(I-1). A method for producing a bread product or bread dough with reduced oil absorption, comprising the step of:

(1) preparing bread dough by incorporating at least one member selected from the group consisting of konnyaku gel and konnyaku sol into ingredients of the bread dough.

(I-2). The method according to Item (I-1), wherein the konnyaku gel and the konnyaku sol are prepared using 100 parts by weight of konnyaku powder and 1,000 to 6,000 parts by weight of water.
(I-3). The method according to Item (I-1) or (I-2), wherein the at least one member selected from the group consisting of konnyaku gel and konnyaku sol is incorporated into the ingredients of the bread dough in the gross amount of 10 to 80 parts by weight per 100 parts by weight of grain powder contained in the ingredients of the bread dough.
(I-4). The method according to any one of Items (I-1) to (I-3), wherein the bread product with reduced oil absorption is bread crumbs with reduced oil absorption,

the method further comprising, after the step (1), the steps of:

(2a) fermenting the bread dough, and baking the bread dough; and

(3a) pulverizing the bread obtained in the step (2a) to prepare bread crumbs.

(I-5). The method according to Item (I-4), further comprising the step of:

(4a) drying the bread crumbs obtained in the step (3a).

(I-6). The method according to any one of Items (I-1) to (I-3), wherein the bread product with reduced oil absorption is a doughnut or a deep-fried bread with reduced oil absorption,

the method further comprising, after the step (1), the step of:

(2b) fermenting the bread dough prepared in step (1) and deep-frying the fermented bread dough.

(I-7). Bread crumbs with reduced oil absorption produced by any one of the methods according to any one of Items (I-1) to (I-5)
(I-8). A doughnut or a deep-fried bread with reduced oil absorption produced by any one of the methods according to any one of Items (I-1) to (I-3), and (I-6).
(I-9). Bread dough of a doughnut or a deep-fried bread with reduced oil absorption produced by any one of the methods according to any one of Items (I-1) to (I-3).
(I-10). A frozen bread dough of a doughnut or a deep-fried bread with reduced oil absorption, produced by freezing the bread dough according to Item (I-9).

### (II) Deep-Fried Food Products and Food Products for Deep-Frying

(II-1). A deep-fried food product or food product for deep-frying prepared using the bread crumbs with reduced oil absorption according to Item (I-7).
(II-2). The deep-fried food product or food product for deep-frying according to Item (II-1), wherein the food product for deep-frying is a food product which has not been deep-fried but readied for deep-frying, prepared using the bread crumbs with reduced oil absorption according to Item (I-7).
(II-3). The deep-fried food product or food product for deep-frying according to Item (II-1), wherein the food product for deep-frying is a frozen food product which has not been deep-fried but readied for deep-frying, prepared using the bread crumbs with reduced oil absorption according to Item (I-7).
(II-4). The deep-fried food product or food product for deep-frying according to Item (II-1), wherein the deep-fried food product is a food product which has been deep-fried using the bread crumbs with reduced oil absorption according to Item (I-7).

### (III) Methods for Reducing Oil Absorption of Bread Products

(III-1). A method for reducing oil absorption of a bread product, comprising the step of:

(1) incorporating, at least one member selected from the group consisting of konnyaku gel and konnyaku sol into ingredients of bread dough during a process of producing a bread product.

(III-2). The method according to Item (III-1), wherein the konnyaku gel and konnyaku sol are prepared using 100 parts by weight of konnyaku powder and 1,000 to 6,000 parts by weight of water.
(III-3). The method according to (III-1) or (III-2), wherein the at least one member selected from the group consisting of konnyaku gel and konnyaku sol is incorporated into the ingredients of the bread dough in the gross amount of 10 to 80 parts by weight per 100 parts by weight of grain powder contained in the ingredients of the bread dough.
(III-4). The method according to any one of Items (III-1) to (III-3), wherein the bread product with reduced oil absorption is bread crumbs with reduced oil absorption,

the method further comprising, after the step (1), the steps of:

(2a) fermenting the bread dough, and baking the bread dough; and

(3a) pulverizing the bread obtained in the step (2a) to prepare bread crumbs.

(III-5). The method according to Item (III-4), further comprising the step of:

(4) drying the bread crumbs obtained in the step (3a).

(III-6). The method according to any one of Items (III-1) to (III-3), wherein the bread product with reduced oil absorption is a doughnut or a deep-fried bread,

the process further comprising, after the step (1), the step of:

(2b) deep-frying the bread dough prepared in step (1).

### Effect of Invention

The production method of the present invention enables production of bread products, particularly bread crumbs, doughnuts, and deep-fried breads with reduced oil absorbency (oil absorption), and allows easy drainage of oil. Accordingly, by preparing deep-fried food products and food products for deep-frying using the bread crumbs prepared by the aforementioned method, it is possible to produce deep-fried food products and food products for deep-frying with reduced oil absorption and reduced calories. Since the post-deep-frying food products (deep-fried food products) thus produced can easily drain off the oil, the usual greasy stickiness is reduced, and the products have a pleasant texture (crispness). Further, the doughnuts and deep-fried breads produced by the aforementioned method have reduced oil absorption and low calories.

Conventional deep-fried food products had drawbacks such as stickiness, greasiness, etc. which appear with time, decreasing the taste or texture thereof. In contrast, the doughnuts and deep-fried breads produced by the method of the present invention, and the deep-fried food products prepared by using the bread crumbs of the present invention, have less stickiness and greasiness because of the above advantages of reduced oil absorption and easy drainage of extra oil. Therefore, the deep-fried food products are less sticky and greasy, and keep a good texture (for example, crispy texture) during long-term conservation. The deep-fried food products exhibit the same effect when they are reheated in a microwave oven. That is, the crispy texture can be maintained after being reheated in a microwave oven. Further, since the bread crumbs, doughnuts and deep-fried breads of the present invention contain glucomannan derived from the konnyaku gel or sols incorporated therein, the bread crumbs and deep-fried products of the present invention are conducive to the reduction of blood glucose level and cholesterol.

### BRIEF DESCRIPTION OF DRAWINGS

FIG. 1 shows how konnyaku sol and konnyaku gel affect the oil absorbency of dry bread crumbs (Experiment Example 1). The gray bar denotes oil absorbency (%), while the black bar denotes the oil reduction rate (%).

FIG. 2 shows how konnyaku gel (25), konnyaku gel (33) and konnyaku gel (40) affect the oil absorbency of raw bread crumbs.

FIG. 3 shows how konnyaku gel (25), konnyaku gel (33) and konnyaku gel (40) affect the oil absorbency of dry bread crumbs.

FIG. 4 shows how the particle size of raw bread crumbs containing konnyaku gel affects the oil absorbency (%).

FIG. 5 shows how the particle size of dry bread crumbs containing konnyaku gel affects the oil absorbency (%).

### MODE FOR CARRYING OUT THE INVENTION

(I) Bread Product with Reduced Oil Absorption, its Bread Dough, and Their Production Methods

The bread product and bread dough with reduced oil absorption of the present invention is characterized by its production method, which uses konnyaku gel or konnyaku sol as one of the ingredients of bread dough. More specifically, the bread product and the bread dough with reduced oil absorption of the present invention are characterized by a bread dough preparation step comprising incorporating at least one member selected from the group consisting of konnyaku gel and konnyaku sol. The konnyaku sol is prepared by adding water to konnyaku powder to make the powder swell. The preparation method is not limited; however, one exemplary method involves mixing konnyaku powder with water adjusted to 30° C. or lower, and stirring the mixture for about 5 to 10 minutes. The ratio of water to konnyaku powder is not limited. For example, 100 to 6,000 parts by weight of water can be added with respect to 100 parts by weight of konnyaku powder. The ratio of water is more preferably 2,000 to 5,000 parts by weight, further preferably 2,500 to 3,500 parts by weight. Upon preparation of the konnyaku sol in this method, by adding 3 to 10 parts by weight, preferably 5 to 7 parts by weight of an alkaline agent to 100 parts by weight of konnyaku powder, adjusting the mixture to have a pH value of 9 or greater, preferably 10 to 11.5, and stirring the mixture under heat, it is possible to produce konnyaku gel.

The heating temperature and heating time are not particularly limited. Generally, the heating is performed at 60° C. to 110° C., preferably 70° C. to 90° C., for 5 to 40 minutes, preferably 5 to 15 minutes. A suitable alkaline agent is an alkaline agent for use in a food additive, and that is capable of adjusting the konnyaku sol to have a pH value of 9 or greater, preferably 10 to 11.5. Examples of alkaline agents include calcium salts such as calcium hydroxide or eggshell calcium, and sodium salts such as sodium carbonate or sodium hydrogen carbonate. The bread products provided by the present invention include (a) a bread product for use for preparation of deep-fried food products and food products for deep-frying, and (b) a bread product produced by deep-frying. An example of the product (a) is bread crumbs, and an example of the product (b) is doughnuts or deep-fried breads. The deep-fried breads denote bread products produced by deep-frying fermented bread dough instead of baking the dough. A typical example of the bread dough for bread products of the present invention is bread dough for the bread product (b) (doughnuts or deep-fried bread).

The following specifically explains (a) bread crumbs with reduced oil absorption, and (b) doughnuts or deep-fried breads with reduced oil absorption, and the bread dough thereof.

(a) Bread Crumbs with Reduced Oil Absorption and their Production Method

The bread crumbs with reduced oil absorption of the present invention is produced through the same method and has the same composition as those for general bread for use in bread crumbs, except that the bread is produced by incorporating at least one member selected from the group consisting of konnyaku gel and konnyaku sol as an ingredient of the bread dough. More specifically, the bread crumbs are prepared by carrying out a step (1) of preparing bread dough using at least one member selected from the group consisting of konnyaku gel and konnyaku sol; a step (2a) of fermenting the bread dough and baking the bread dough; and a step (3a) of pulverizing the baked bread to prepare the bread crumbs. In the step (1), at least one member selected from the group consisting of konnyaku gel and konnyaku sol is added to the ingredients of bread dough of general bread for the preparation of bread crumbs, such as grain powder, salt, sugar, yeast, butter, and an emulsifier as necessary. Then, water is added to the mixture, and the mixture is kneaded. Thereafter, oil (shortening) is added to the mixture as required, and the mixture is further kneaded to prepare bread dough.

The ratio of the konnyaku gel or konnyaku sol is, in the gross amount, 10 to 80 parts by weight, preferably 20 to 40 parts by weight, more preferably 20 to 30 parts by weight, per 100 parts by weight of the grain powder used for the preparation of the bread. If the proportion of the konnyaku gel or konnyaku sol is far less than 10 parts by weight, the aforementioned effects of the present invention tend to decrease. If the proportion of the konnyaku gel or konnyaku sol is far greater than 80 parts by weight, a great expense is required, and the resulting bread crumbs become too hard. The grain powder is not particularly limited insofar as it is general powder grain used as an ingredient of bread dough; examples thereof include wheat, rice, rye, oats, barley, corn, buckwheat, and millet powder. A particularly preferred grain powder is flour (including hard flour, medium-strength flour and soft flour). The grain powder may be whole-grain powder.

The bread dough thus prepared is then baked after a general fermentation step. The method of kneading and fermenting the bread dough is not particularly limited; both the so-called sponge dough and straight dough methods can be adopted. The method of baking the bread dough is not particularly limited, and usual methods, such as baking or ohmic heating, may be adopted. The bread thus produced is then pulverized into bread crumbs. The method for pulverizing the bread is not particularly limited, and can be performed by a usual method. The bread is usually pulverized into bread crumb powder of about 45 mesh particles to coarse bread crumbs of about 2 mesh particles. In terms of oil absorption and texture, the bread is preferably pulverized into about 5 mesh particles or greater, more preferably 10 mesh particles or greater.

The pulverized bread crumbs may be dried into dry bread crumbs, or into semi-dry bread crumbs. The pulverized bread crumbs may also be used as raw bread crumbs without a drying step. More specifically, the bread crumbs of the present invention include dry bread crumbs, semi-dry bread crumbs, and raw bread crumbs. Dry bread crumbs are preferable because of their low oil absorption (see Experiment Example 2).

In the present invention, “bread crumbs with reduced oil absorption” refers to bread crumbs with low oil absorption during deep-frying. More specifically, the “bread crumbs with reduced oil absorption” are defined as bread crumbs having a lower oil absorbency (oil absorbency is measured based on an increase in weight after deep-frying) than the oil absorbency of bread crumbs prepared under exactly the same conditions except for the incorporation of konnyaku gel or konnyaku sol. Although it varies from the moisture content of konnyaku gel or konnyaku sol, the amount of konnyaku gel or konnyaku sol, the drying degree of the bread crumbs etc., the oil absorbency of the bread crumbs with reduced oil absorption of the present invention is preferably in a range of from about 20% to 36%, which is about 5% to 40% lower than the oil absorbency (generally about 35% to 60%) of the bread crumbs prepared under exactly the same conditions except for the incorporation of konnyaku gel or konnyaku sol.

The present invention also provides deep-fried food products and food products for deep-frying prepared by using the bread crumbs with reduced oil absorption, which are prepared through the above method. In the present invention, “deep-fried food products and food products for deep-frying” refers to food products cooked using oil and food products to be cooked using oil, which contain the above bread crumbs with reduced oil absorption. More specifically, “deep-fried food products and food products for deep-frying” refers to food products with the bread crumbs with reduced oil absorption coated therewith. The deep-fried food products and food products for deep-frying of the present invention include not only the products already deep-fried (deep-fried food products), but also the products readied for deep-frying but that have not yet been deep-fried (a product covered with bread crumbs with reduced oil absorption before being fried: food products for deep-frying). The deep-fried food products and food products for deep-frying of the present invention may be frozen or unfrozen. Examples of the frozen foods include frozen foods already deep-fried, and frozen foods readied for deep-frying (covered with bread crumbs with reduced oil absorption, but that have not yet been deep-fried). The materials of the deep-fried food products and food products for deep-frying are not limited, and can be selected from a wide range of meats, seafood, vegetables, and wild grasses.

(b) Doughnuts and Deep-Fried Breads with Reduced Oil Absorption, the Bread Dough Thereof, and their Production Methods

The doughnuts and deep-fried breads with reduced oil absorption of the present invention are produced using usual formulations and production methods for doughnuts or deep-fried breads, except for the incorporation of at least one member selected from the group consisting of konnyaku gel and konnyaku sol as an ingredient of bread dough. More specifically, in addition to step (1) of adding at least one member selected from the group consisting of konnyaku gel and konnyaku sol to prepare bread dough, the production method comprises a step (2b) of fermenting the prepared bread dough and deep-frying the fermented bread dough.

In step (1), at least one member selected from the group consisting of konnyaku gel and konnyaku sol is added to ingredients of bread dough for use in the general production of doughnuts or deep-fried breads, such as grain powder, salt, sugar, yeast, butter, and an emulsifier as necessary. Then, water is added to the mixture, and the mixture is kneaded. Thereafter, oil (shortening) is added to the mixture as required, and the mixture is further kneaded to prepare bread dough.

The ratio of the konnyaku gel or konnyaku sol is, in the gross amount, 10 to 80 parts by weight, preferably 20 to 40 parts by weight, more preferably 20 to 30 parts by weight, per 100 parts by weight of grain powder in ingredients of the bread dough. If the proportion of the konnyaku gel or konnyaku sol is less than 10 parts by weight, the aforementioned effects of the present invention tend to decrease. If the proportion of the konnyaku gel or konnyaku sol is greater than 80 parts by weight, a great expense is required, and the resulting bread crumbs tend to become too hard. As described above, the grain powder is not particularly limited insofar as it is general powder grain used as an ingredient of bread dough. A particularly preferred grain powder is flour (including hard flour, medium-strength flour and soft flour). The grain powder may be whole-grain powder.

The bread dough thus prepared is subjected to a general fermentation step, formed into a desired shape, and then deep-fried. The method of kneading and fermenting the bread dough is not particularly limited; both the so-called sponge dough and straight dough methods can be adopted. The method of deep-frying the bread dough is not particularly limited, and usual deep-frying methods may be adopted.

In the present invention, “doughnuts and deep-fried breads with reduced oil absorption” refers to doughnuts and deep-fried breads with low oil absorption during deep-frying. More specifically, the “doughnuts and deep-fried breads with reduced oil absorption” is defined as doughnuts and deep-fried breads having a lower oil absorbency (oil absorbency is measured based on an increase in weight after deep-frying) than the oil absorbencies of doughnuts and deep-fried breads prepared under exactly the same conditions except for the incorporation of konnyaku gel or konnyaku sol. Although it varies from the moisture content of konnyaku gel or konnyaku sol, the amount of konnyaku gel or konnyaku sol, the drying degree of the bread crumbs etc., the oil absorbencies of the doughnuts and deep-fried breads with reduced oil absorption of the present invention are preferably in a range of from about 5% to 20%, which is about 10% to 40% lower than the oil absorbencies (generally about 10% to 30%) of the doughnuts and deep-fried breads prepared under exactly the same conditions except for the incorporation of konnyaku gel or konnyaku sol.

The present invention also provides bread dough, which is the dough to be used for the production methods of doughnuts or deep-fried breads, i.e., the dough before the deep-frying. The bread dough may be frozen.

### (II) Method of Reducing Oil Absorption of Bread Products

The present invention provides a method of reducing oil absorption of bread products.

As described above, the bread products of the present invention include (a) bread products for use in deep-fried food products and food products for deep-frying, such as bread crumbs; and (b) bread products prepared through a deep-frying process, such as doughnuts or deep-fried breads.

The method of the present invention comprises preparing bread crumbs, doughnuts or deep-fried breads by incorporating at least one member selected from the group consisting of konnyaku gel and konnyaku sol into the bread dough of bread for use in bread crumbs, or the bread dough of doughnuts or deep-fried breads.

More specifically, the method may be adopted in the production of bread crumbs by carrying out the step (1) of adding at least one member selected from the group consisting of konnyaku gel and konnyaku sol to the ingredients of bread dough, the step (2a) of fermenting the prepared bread dough and baking the fermented bread dough, and a step (3a) of pulverizing the baked bread. As required, a step (4a) of drying the pulverized bread crumbs may also be performed.

Further, the method may also be adopted in the production of doughnuts or deep-fried breads by carrying out the step (1) of adding at least one member selected from the group consisting of konnyaku gel and konnyaku sol to the ingredients of bread dough, and the step (2b) of fermenting the prepared bread dough and deep-frying the fermented bread dough.

The method for producing konnyaku gel and konnyaku sol, the moisture content of konnyaku gel or konnyaku sol, the amount of konnyaku gel and konnyaku sol in the production of the bread products, and the production process of bread crumbs using the konnyaku gel and konnyaku sol are the same as those detailed in the above section (I). The above conditions are also adopted in the method of reducing oil absorption of bread products.

### EXAMPLES

The present invention is more specifically explained below in reference to Examples and Experiment Examples. The present invention is, however, not limited to these examples etc.

### Reference Preparation Example 1

### Method of Preparing Konnyaku Sol

33 kg of water at 30° C. was added to 1 kg of konnyaku powder (Seijitsumura, K.K.), and the mixture was stirred for 10 minutes to make it swell, thereby obtaining a konnyaku sol (33).

The konnyaku sol (33) was used in the following experiment.

### Reference Preparation Example 2

### Method of Preparing Konnyaku Gel

50 g of calcium hydroxide and 25 kg, 33 kg, or 40 kg of water at 30° C. were added to 1 kg of konnyaku powder (Seijitsumura, K.K.), and the mixture was stirred for 15 minutes. The mixture was heated for 30 minutes at 85° C. to obtain a gel. These konnyaku gel (25), konnyaku gel (33), and konnyaku gel (40) were used in the following experiments.

### Examples 1 to 5

Bread loaves were produced by a usual method according to the formulations in Table 1, using konnyaku sol (33) prepared according to the method of Reference Preparation Example 1 (Examples 1 to 5). As a Comparative Example 1, a bread loaf was produced by the same process as above, except that the konnyaku sol (33) was not added to the dough. More specifically, first, all of the ingredients of bread dough shown in Table 1 were mixed. The resulting bread dough was placed in a dough box for primary fermentation. Thereafter, the fermented dough was divided into equal quantities, and each portion was rounded using a rounder. The rounded dough was benched and punched down before being placed in a loaf mold. The bread dough in each loaf mold was placed in a final proof compartment for final proof. The fermented dough was baked in an ohmic-heating oven or a baking oven to obtain a bread loaf. The obtained bread loaves were allowed to stand for adequate time for cooling, and pulverized for seven seconds using a food cutter, thereby producing raw bread crumbs (raw bread crumbs according to Examples 1 to 5). Further, the raw bread crumbs were air-dried at 60° C. for 70 minutes to obtain dry bread crumbs (dry bread crumbs according to Examples 1 to 5).

| | Comparative | Exam- | Exam- | Exam- | Exam- | Exam- |
|---|---|---|---|---|---|---|
| | Example 1 | ple 1 | ple 2 | ple 3 | ple 4 | ple 5 |
| Flour* | 500 | 500 | 500 | 500 | 500 | 500 |
| Konnyaku | 0 | 100 | 150 | 200 | 300 | 400 |
| sol(33) | | | | | | |
| Sugar | 25 | 25 | 25 | 25 | 25 | 25 |
| Salt | 10 | 10 | 10 | 10 | 10 | 10 |
| Powder | 15 | 15 | 15 | 15 | 15 | 15 |
| milk | | | | | | |
| Yeast | 5 | 5 | 5 | 5 | 5 | 5 |
| Salt-free | 0 | 0 | 0 | 0 | 0 | 0 |
| butter | | | | | | |
| Water | 360 | 315 | 280 | 250 | 200 | 130 |
| Whole | 915 | 970 | 985 | 1005 | 1055 | 1085 |
| weight | | | | | | |

(1) Product name “Golden Yacht” (hard flour for bread; Nisshin Flour Milling Co.)

### Examples 6 to 10

### Method of Producing Bread Crumbs Using Konnyaku Gel

Using methods similar to the methods in Examples 1 to 5, bread loaves were produced according to the formulations in Table 2, using konnyaku sol (33) prepared according to the method of Reference Preparation Example 2 (Examples 6 to 10). As a Comparative Example 1, a bread loaf was produced by the same process as above, except that the konnyaku sol (33) was not added to the dough. The obtained bread loaf was pulverized for seven seconds using a food cutter, thereby producing raw bread crumbs (raw bread crumbs according to Examples 6 to 10). Further, the raw bread crumbs were air-dried at 60° C. for 70 minutes to obtain dry bread crumbs (dry bread crumbs according to Examples 6 to 10).

Further, more bread loaves were produced according to the formulations in Table 2, using konnyaku gel (25) and konnyaku gel (40) (konnyaku gel (25) was used in Examples 11 to 15, and konnyaku gel (40) was used in Examples 16 to 20), and raw bread crumbs (raw bread crumbs of Examples 11 to 20) and dry bread crumbs (dry bread crumbs of Examples 11 to 20) were produced in the same manner as above from the obtained bread loaves.

TABLE 2

| | | Examples | | | | |
|---|---|---|---|---|---|---|
| | Comparative | 6, 11, | 7, 12, | 8, 13, | 9, 14, | 10, 15, |
| | Example 1 | 16 | 17) | 18 | 19 | 20 |
| Flour* | 500 | 500 | 500 | 500 | 500 | 500 |
| Konnyaku | 0 | 100 | 150 | 200 | 300 | 400 |
| sol⁽²⁾ | | | | | | |
| Sugar | 25 | 25 | 25 | 25 | 25 | 25 |
| Salt | 10 | 10 | 10 | 10 | 10 | 10 |
| Powder | 15 | 15 | 15 | 15 | 15 | 15 |
| milk | | | | | | |
| Yeast | 5 | 5 | 5 | 5 | 5 | 5 |
| Salt-free | 0 | 0 | 0 | 0 | 0 | 0 |
| butter | | | | | | |
| Water | 360 | 315 | 280 | 250 | 200 | 130 |
| Whole | 915 | 970 | 985 | 1005 | 1055 | 1085 |
| weight | | | | | | |

⁽¹⁾“Golden Yacht” (hard flour for bread; Nisshin Flour Milling Co.)
⁽²⁾Examples 6 to 10: konnyaku gel (33)
Examples 11 to 15: konnyaku gel (25)
Examples 16 to 20: konnyaku gel (40)

Table 3 shows nutritional content regarding the raw bread crumbs and dry bread crumbs according to Example 7 produced by incorporating 30 parts by weight of konnyaku gel (33) per 100 parts by weight of flour. The nutritional content is based on the Standard Tables of Food Composition in Japan, Fifth Revised and Enlarged Edition. For comparison, the table also shows the nutritional content of commercially available raw bread crumbs (n=2) and dry bread crumbs (n=6).

TABLE 3

| | | | Commercially | Commercially |
|---|---|---|---|---|
| | Dry bread | Raw bread | available dry | available raw |
| | crumbs of | crumbs of | bread crumbs | bread crumbs |
| Items | Example 7 | Example 7 | (n = 6) | (n = 2) |
| Water (g/100 | 11.2 | 51.4 | 10.5 | 37.9 |
| g) | | | | |
| Protein (g/100 | 12.8 | 7.4 | 12.4 | 10.3 |
| g) | | | | |
| Lipid (g/100 | 1.3 | 0.8 | 3.7 | 4.8 |
| g) | | | | |
| Ash (g/100 g) | 2.4 | 1.2 | 1.2 | 2.4 |
| Carbohydrate | 0.573 | 39.2 | 72.2 | 44.7 |
| (g/100 g) | | | | |
| Water activity | 0.573 | 0.977 | 0.594 | 0.972 |

As shown in Table 3, the water activities of the raw bread crumbs and dry bread crumbs of Example 7 were 0.977 and 0.573, respectively. This shows that their water activities are almost equal to those of the commercially available raw bread crumbs and dry bread crumbs. The raw bread crumbs were conservable for a long period in an oxygen-free packing using a deoxidizer or the like, or in a nitrogen substitution packing. The dry bread crumbs were conservable without an oxygen-free packing and a nitrogen substitution packing.

### Experiment Example 1

### Influence of Konnyaku Sol or Konnyaku Gel on Oil Absorption of Bread Crumbs

The oil absorbencies of the following three kinds of bread crumbs were compared.

Dry bread crumbs of Example 2, which were prepared from the bread loaf (Example 2) produced by incorporating 30 parts by weight of konnyaku sol (33) prepared according to the method of Reference Preparation Example 1, per 100 parts by weight of flour.

Dry bread crumbs of Example 7, which were prepared from the bread loaf (Example 7) produced by incorporating 30 parts by weight of konnyaku gel (33) prepared according to the method of Reference Preparation Example 2, per 100 parts by weight of flour.

Dry bread crumbs of Comparative Example 1, which were prepared from the bread loaf (Comparative Example 1) produced without incorporating konnyaku sol (33) or konnyaku gel (33).

### (1) Deep-Frying

20 g each of the three kinds of dry bread crumbs (dry bread crumbs of Examples 2 and 7, dry bread crumbs of Comparative Example 1) were directly deep-fried in 180° C. oil for 30 seconds. The deep-fried crumbs were taken out and placed on a grid to drain off the oil.

### (2) Measurement of Oil Absorbency

The three kinds of dry bread crumbs thus deep-fried were subjected to Soxhlet extraction using diethyl ether according to Standard Tables of Food Composition in Japan, Fifth Revised and Enlarged Edition (Subdivision on Resources in Council for Science and Technology, Ministry of Education, Culture, Sports, Science and Technology in Japan), so as to measure the lipid quantity in each kind of bread crumbs.

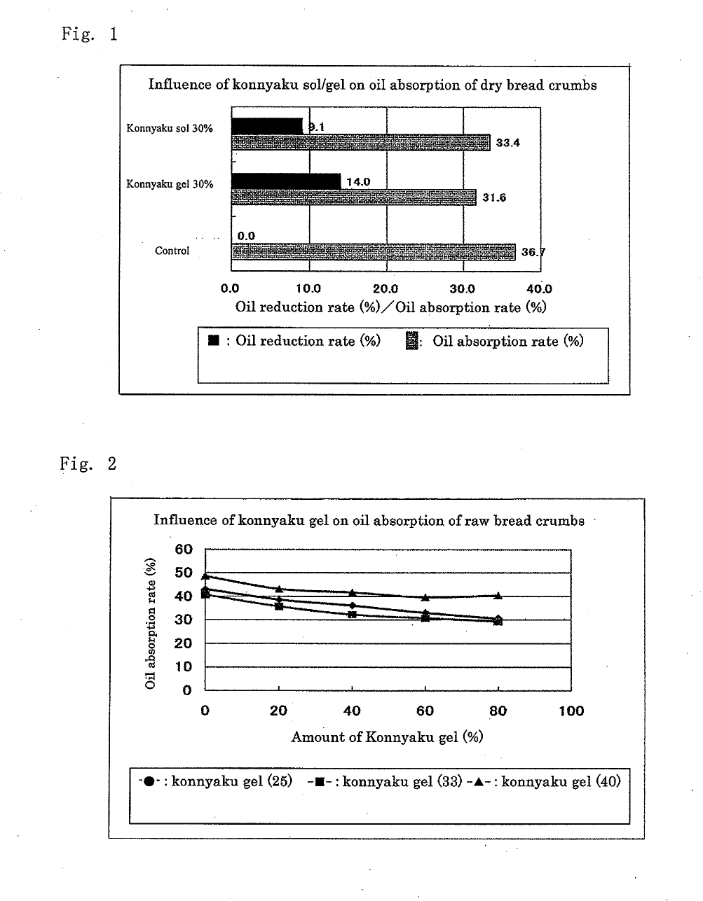

FIG. 1 shows the values. The oil absorbency of the bread crumbs (dry bread crumbs of Comparative Example 1) prepared without incorporating konnyaku sol or konnyaku gel into flour was 36.7%. The oil absorbencies of the bread crumbs of Examples 2 and 7 prepared by incorporating 30 wt % of konnyaku sol (33) and 30 wt % of konnyaku gel (33) into flour were 33.4% and 31.6%, respectively. The results show that bread crumbs with reduced oil absorption can be produced by incorporating konnyaku sol or konnyaku gel into the ingredients of bread dough.

The lipid quantities of the bread crumbs of Examples 2 and 7 after deep-frying were reduced by about 9.1% and about 14%, respectively, compared with bread crumbs prepared without incorporating konnyaku sol or konnyaku gel. The results further show that konnyaku gel has a property of decreasing oil absorption of bread crumbs superior to that of konnyaku sol. It was also confirmed that the reduction in lipid quantity (reduction in calories) of a deep-fried product is greater in a product prepared through the addition of konnyaku gel than in a product prepared through the addition of konnyaku sol.

The average oil absorbencies of the commercially available dry bread crumbs (n=6) and raw bread crumbs (n=2) in Table 3 were very high, 44.1% and 57.9%, respectively.

### Experiment Example 2

Influence of konnyaku gel on oil absorption of bread crumbs The results of Experiment 1 showed that konnyaku gel decreased the oil absorption of bread crumbs more significantly than konnyaku sol. Accordingly, the following experiment used konnyaku gel.

### (1) Influence of Konnyaku Gel on Oil Absorption of Raw Bread Crumbs

The oil absorbencies of the following raw bread crumbs were measured in the same manner as in Experiment 1.

Raw bread crumbs of Comparative Example 1, which were prepared from the bread loaf (Comparative Example 1) produced without incorporating konnyaku sol (33) or konnyaku gel (33).

Raw bread crumbs of Examples 6 and 8 to 10, which were produced by incorporating konnyaku gel (33) prepared in Reference Preparation Example 2 in an amount of 20, 40, 60 and 80 parts by weight, per 100 parts by weight of flour.

Raw bread crumbs of Examples 11 and 13 to 15, which were produced by using konnyaku gel (25).

Raw bread crumbs of Examples 16 and 18 to 20, which were produced by using konnyaku gel (40).

FIG. 2 shows the results.

As shown in FIG. 2, the oil absorbencies of the bread crumbs produced by incorporating konnyaku gel (33) in an amount of 0, 20, 40, 60 and 80 parts by weight, per 100 parts by weight of flour were 40.7%, 35.8%, 32.3%, 30.8%, and 29.4%, respectively. This shows that the oil absorbency decreases with an increase of the ratio of konnyaku gel (33), thereby reducing the fat of a deep-fried product. The same results were obtained in the experiments using konnyaku gel (25) and konnyaku gel (40). The fat of the deep-fried raw bread crumbs produced by incorporating 60 parts by, weight of konnyaku gel (33), konnyaku gel (25), or konnyaku gel (40) per 100 parts by weight of flour was about 20% lower than the deep-fried raw bread crumbs produced without konnyaku gel. Further, with an increase in the ratio of konnyaku gel, the texture of the deep-fried product became harder and crispier. This is presumably because the konnyaku gel incorporated in the bread crumbs was hardened by heat, or because the konnyaku gel and the moisture in the bread crumbs were strongly coupled and thereby repelled the oils.

### (2) Influence of Konnyaku Gel on Oil Absorption of Dry Bread Crumbs

The oil absorbencies of the following dry bread crumbs were measured in the same manner as in Experiment 1.

Dry bread crumbs of Comparative Example 1, which were prepared from the bread loaf (Comparative Example 1) produced without incorporating konnyaku sol (33) or konnyaku gel (33).

Dry bread crumbs of Examples 6 and 8 to 10, which were produced by incorporating konnyaku gel (33) prepared in Reference Preparation Example 2 in an amount of 20, 40, 60 and 80 parts by weight, per 100 parts by weight of flour.

Dry bread crumbs of Examples 11 and 13 to 15, which were produced by using konnyaku gel (25).

Dry bread crumbs of Examples 16 and 18 to 20, which were produced by using konnyaku gel (40).

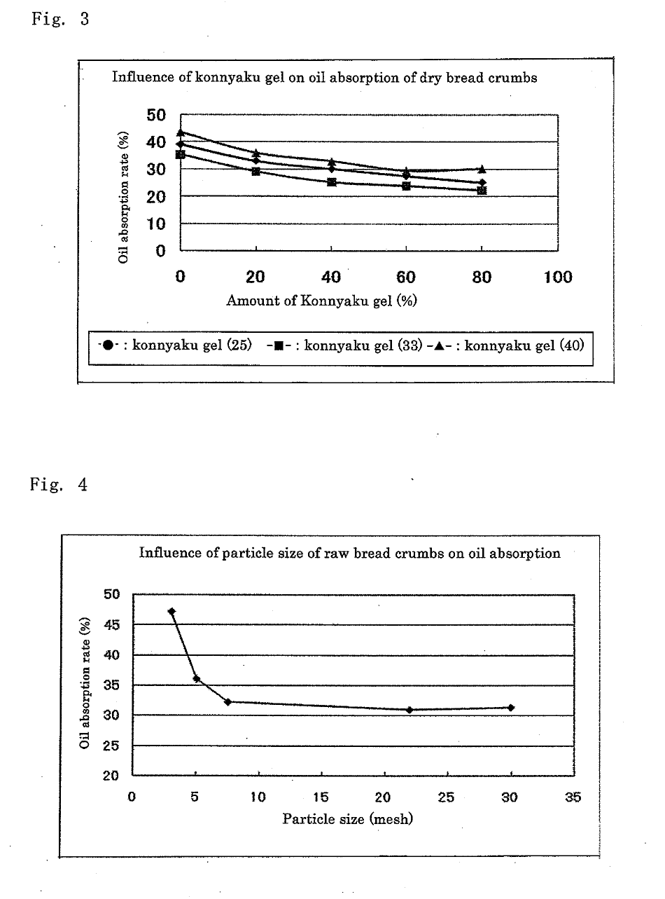

FIG. 3 shows the results.

As shown in FIG. 3, the oil absorbencies of the bread crumbs produced by incorporating konnyaku gel (33) in an amount of 0, 20, 40, 60 or 80 parts by weight, per 100 parts by weight of flour, were 35.4%, 29.2%, 25.3%, 24.0% and 22.4%, respectively. This shows that the oil absorbency decreases with an increase of the ratio of konnyaku gel (33), thereby reducing the fat of a deep-fried product. The same results were obtained in the experiments using konnyaku gel (25) and konnyaku gel (40). The fat of the deep-fried dry bread crumbs produced by incorporating 60 parts by weight of konnyaku gel (33), konnyaku gel (25), or konnyaku gel (40) per 100 parts by weight of flour was about 30% lower than the deep-fried dry bread crumbs produced without incorporating konnyaku gel. Further, as with the raw bread crumbs, the texture of the deep-fried dry bread crumbs became harder and crispier with an increase in the ratio of konnyaku gel.

### Experiment Example 3

### Influence of Particle Size of Bread Crumbs on Oil Absorption

Raw bread crumbs and dry bread crumbs were produced from a bread loaf containing konnyaku gel (33) prepared in Reference Preparation Example 2 in an amount of 30 parts by weight, per 100 parts by weight of flour. The raw bread crumbs and dry bread crumbs were separately screened by particle size using a multilayered vibrating screener. In the screening with the multilayered vibrating screener, the particle size of the bread crumbs was determined according to the last sieve through which the bread crumbs passed.

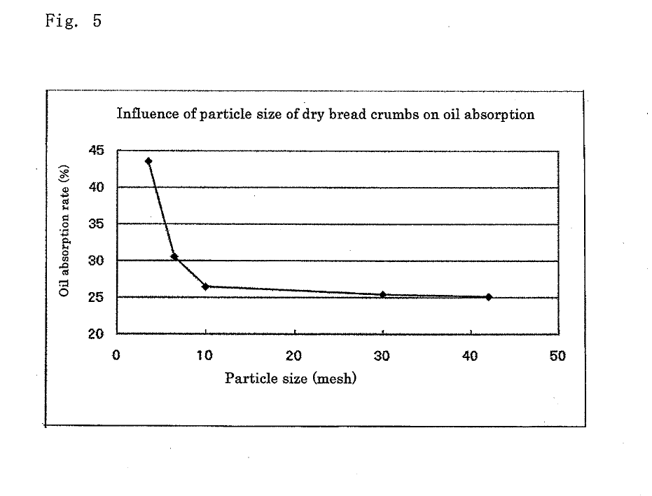

For each size of the bread crumbs (raw bread crumbs and dry bread crumbs), oil absorbency was measured according to the method of Experiment 1. FIG. 4 shows the results for raw bread crumbs, and FIG. 5 shows the results for dry bread crumbs. The results showed that, by adjusting the particle size of bread crumbs to not less than 5 mesh particles, preferably not less than 10 mesh particles, the oil absorbency of the bread crumbs can be further reduced.

### Experiment Example 4

### •Test Method

(1) Chicken cutlets were prepared by coating the surface of chicken breast fillets with the raw bread crumbs of Comparative Example 1 (containing neither konnyaku gel nor konnyaku sol), the raw bread crumbs of Example 2 (containing konnyaku sol (33)) or the raw bread crumbs of Example 7 (containing konnyaku gel (33)). The cutlets were frozen before being deep-fried (frozen chicken cutlets, 10 each for each kind of the raw bread crumbs). The frozen chicken cutlets were deep-fried for 4 minutes in canola oil at 180° C., after which the oil was drained off for 30 seconds. Then, the fried cutlets were placed on a previously weighed layered paper towel for another 10 minutes to further drain off the oil. Thereafter, the paper towel was weighed again, and the difference from the previous weight was calculated to find the weight of the oil drained off from the chicken cutlet.

(2) Thereafter, the chicken cutlets were stored at 5° C. for 24 hours. Then, the texture was evaluated by tasting.

(3) Alternatively, the chicken cutlets stored at 5° C. for 24 hours were reheated in a microwave oven, and the texture was evaluated by tasting.

•Test Results

Table 4 shows the results of the measurement in (1).

TABLE 4

| | Amount of oil drained off from the |
|---|---|
| Used raw bread crumbs | chicken cutlet per slice |
| Comparative Example 1 | 2.7 g |
| Example 2 | 3.3 g |
| Example 7 | 3.5 g |

The results showed that the deep-fried food product (chicken cutlet) cooked using the bread crumbs containing konnyaku sol or konnyaku gel can easily drain off the oil, thereby reducing the amount of oil remaining in the deep-fried product. The oil drainage effect was more significant in the bread crumbs containing konnyaku gel than in the bread crumbs containing konnyaku sol.

Table 5 shows the results of (2) and (3).

TABLE 5

| Used raw | Sensory | | Sensory evaluation | |
|---|---|---|---|---|
| bread | evaluation | Evalu- | after microwave | Evalu- |
| crumbs | after 24 hours | ation | reheating | ation |
| Comparative | Soft and gooey, | X | Soft and very | X |
| Example 1 | not crispy | | gooey, not crispy | |
| Example 2 | Crispy, not so | ◯ | Slightly gooey but | ◯ |
| | gooey but | | modestly crispy; | |
| | slightly soft | | not as soft as that | |
| | | | in Comparative | |
| | | | Example 1 | |
| Example 7 | Hardly gooey, | ⊚ | Slightly gooey but | ⊚ |
| | crispy | | the crispness is | |
| | | | maintained | |

The results revealed that the deep-fried food products (chicken cutlets) prepared using the bread crumbs produced by incorporating konnyaku sol or konnyaku gel did not become gooey even an entire day after deep-frying, and that the crispy texture was maintained. Further, when the product was reheated in a microwave oven, the bread crumb coating did not become overly moist, and the crispy texture was maintained or recovered. This effect was more significant in the bread crumbs containing konnyaku gel than in those containing konnyaku sol.

### Examples 21 and 22

### Production of Doughnuts with Reduced Oil Absorption

The bread dough ingredients in the proportions shown in Table 6 were placed in a vertical bread- and confectionary-making mixer, together with konnyaku gel (33) prepared in Reference Preparation Example 2. The ingredients were mixed in the mixer rotating at low speed. The obtained dough was divided into 40 g portions. Each portion was rounded, and a hole was cut from the center of the dough using a cutter to form a ring shape 2 cm in thickness, 10 cm in outer diameter, and 6 cm in inner diameter. The dough was allowed to stand for fermentation for 30 minutes at 40° C. Thereafter, each dough portion was deep-fried with shortening at 170° C. for 90 seconds, and then turned over and deep-fried for another 90 seconds to cook the reverse side. Three kinds of doughnuts (Examples 21 and 22, and Comparative Example 1) were obtained. The deep-fried doughnuts were allowed to stand for five minutes to drain off the oil.

TABLE 6

| | | | Comparative |
|---|---|---|---|
| | Example 21 | Example 22 | Example 1 |
| Flour (soft flour) | 115 g | 115 g | 115 g |
| Sugar | 50 g | 50 g | 50 g |
| Baking powder | 3 g | 3 g | 3 g |
| Konnyaku gel | 17 g | 34 g | — |
| Water | 50 g | 50 g | 50 g |
| Total | 218 g | 218 g | 218 g |

### Experiment Example 5

### Oil Absorption Reduction Rate and Calorie Reduction Rate of Doughnuts with Reduced Oil Absorption

The lipid quantities of the above doughnuts (Examples 21 and 22, and Comparative Example 1) were measured as follows. Based on the lipid quantities, the oil absorption reduction rates and calorie reduction rates were calculated.

### (1) Measurements of Lipid Quantity and Oil Absorption Reduction Rate

The above doughnuts (Examples 21 and 22, and Comparative Example 1), which were left to drain off the oil, were pulverized and subjected to Soxhlet extraction using diethyl ether according to the Standard Tables of Food Composition in Japan, Fifth Revised and Enlarged Edition (Subdivision on Resources in Council for Science and Technology, Ministry of Education, Culture, Sports, Science and Technology in Japan), thereby measuring the lipid quantity of each doughnut, and calculating the oil absorption reduction rate.

Table 7 shows the results.

TABLE 7

| | | | | Lipid ratio based | Oil |
|---|---|---|---|---|---|
| | Weight of | Weight of | Lipid | on Comparative | absorption |
| | shaped | deep-fried | quantity | Example 1 (Comparative | reduction |
| | dough | dough | (per 100 g) | Example 1 = 100%) | rate |
| Comparative | 40 g | 44.8 g | 21.9 g | 100% | — |
| Example 1 | | | | | |
| Example 21 | 40 g | 40.2 g | 17.3 g | 79% | 21% |
| Example 22 | 40 g | 39.9 g | 14.0 g | 64% | 36% |

### (2) Measurement of Energy Amount and Calorie Reduction Rate

Based on the obtained lipid quantity, the calories (energy amount) (Kcal) of each doughnut were measured according to the Standard Tables of Food Composition in Japan, Fifth Revised and Enlarged Edition, thereby measuring the calorie reduction rate.

Table 8 shows the results.

TABLE 8

| | | | Lipid ratio based | | |
|---|---|---|---|---|---|
| | Weight of | Weight of | on Comparative | Energy | Calorie |
| | shaped | deep-fried | Example 1 (Comparative | amount | reduction |
| | dough | dough | Example 1 = 100%) | (Kcal) | rate |
| Comparative | 40 g | 44.8 g | 100% | 190 | — |
| Example 1 | | | | | |
| Example 21 | 40 g | 40.2 g | 79% | 158.6 | 16.5% |
| Example 22 | 40 g | 39.9 g | 64% | 149.7 | 21.3% |

The results show that, assuming the lipid content of the doughnut (Comparative Example 1) that does not contain konnyaku gel is 100%, the lipid contents of the doughnuts (Examples 21 and 22) containing 7.8 wt % and 15.6 wt % of konnyaku gel were 79% and 64%, respectively. Accordingly, the oil absorptions of the doughnuts of Examples 21 and 22 were reduced by 21% and 36%. Further, due to the reduction in oil absorption, their energy amounts (Kcal) were also greatly reduced by 16.5% to 21.3%, compared with usual doughnuts (Comparative Example 1). The experiment thus demonstrated the production of low-calorie doughnuts.

Furthermore, due to the reduction in oil absorption of the doughnuts by incorporating konnyaku gel into the bread dough, the yield of oil used for the deep-frying is increased (i.e., the rate of reduction in the oil amount is decreased). Accordingly, the method of the present invention can reduce the consumption of oil for deep-frying in the production of doughnuts or deep-fried breads, or in the production of deep-fried food products using the bread crumbs of the present invention. The method of the present invention is thereby conducive to reduction in production cost.

1. A method for producing a bread product or bread dough with reduced oil absorption, comprising the step of:
(1) preparing bread dough by incorporating at least one member selected from the group consisting of konnyaku gel and konnyaku sol into ingredients of the bread dough.

2. The method according to claim 1, wherein the konnyaku gel and the konnyaku sol are prepared using 100 parts by weight of konnyaku powder and 1,000 to 6,000 parts by weight of water.

3. The method according to claim 1, wherein the at least one member selected from the group consisting of konnyaku gel and konnyaku sol is incorporated into the ingredients of the bread dough in the gross amount of 10 to 80 parts by weight per 100 parts by weight of grain powder contained in ingredients of the bread dough.

4. The method according to claim 1, wherein the bread product with reduced oil absorption is bread crumbs with reduced oil absorption,
the method further comprising, after the step (1), the steps of:
(2a) fermenting the bread dough, and baking the bread dough; and
(3a) pulverizing the bread obtained in the step (2a) to prepare bread crumbs.

5. The method according to claim 4, further comprising the step of:
(4a) drying the bread crumbs obtained in the step (3a).

6. The method according to claim 1, wherein the bread product with reduced oil absorption is a doughnut or a deep-fried bread with reduced oil absorption,
the method further comprising, after the step (1), the step of:
(2b) fermenting the bread dough prepared in step (1) and deep-frying the fermented bread dough.

7. Bread crumbs with reduced oil absorption produced by any one of the methods according to claims 1 to 5.

8. A deep-fried food product or food product for deep-frying prepared using the bread crumbs with reduced oil absorption according to claim 7.

9. A doughnut or a deep-fried bread with reduced oil absorption produced by any one of the methods according to claims 1 to 3, and 6.

10. A bread dough of a doughnut or a deep-fried bread with reduced oil absorption produced by any one of the methods according to claims 1 to 3, and 6.

11. A frozen bread dough of a doughnut or a deep-fried bread with reduced oil absorption, produced by freezing the bread dough according to claim 10.

12. A method for reducing oil absorption of a bread product, comprising the step of:
(1) incorporating at least one member selected from the group consisting of konnyaku gel and konnyaku sol into ingredients of bread dough during a process of producing a bread product.

13. The method according to claim 12, wherein the konnyaku gel and konnyaku sol are prepared using 100 parts by weight of konnyaku powder and 1,000 to 6,000 parts by weight of water.

14. The method according to claim 12, wherein the at least one member selected from the group consisting of konnyaku gel and konnyaku sol is incorporated into the ingredients of the bread dough in the gross amount of 10 to 80 parts by weight per 100 parts by weight of grain powder contained in ingredients of the bread dough.

15. The method according to claim 12, wherein the bread product with reduced oil absorption is bread crumbs with reduced oil absorption,
the method further comprising, after the step (1), the steps of:
(2a) fermenting the bread dough, and baking the bread dough; and
(3a) pulverizing the bread obtained in the step (2a) to prepare bread crumbs.

16. The method according to claim 15, further comprising the step of:
(4) drying the bread crumbs obtained in the step (3a).

17. The method according to claim 12, wherein the bread product with reduced oil absorption is a doughnut or a deep-fried bread,
the method further comprising, after the step (1), the step of:
(2b) deep-frying the bread dough prepared in step (1).
